(19) United States
(12) Patent Application Publication
(10) Pub. No.: US 2026/0296144 A1
(43) Pub. Date: Oct. 1, 2026

(54) TEMPERATURE CONTROL SYSTEM FOR ELECTRIC VEHICLE

(71) Applicant: Mazda Motor Corporation, Aki-gun (JP)

(72) Inventors: Shoko Horibata, Aki-gun (JP); Yuma Miyauchi, Aki-gun (JP)

(21) Appl. No.: 19/454,709

(22) Filed: Jan. 21, 2026

(30) Foreign Application Priority Data
Mar. 31, 2025 (JP) 2025-057543

(51) Int. Cl. B60H 1/32; B60H 1/00

(52) U.S. Cl. CPC B60H 1/323; B60H 1/00278; B60H 2001/00307; B60H 2001/3289

(57) ABSTRACT

A temperature control system for an electric vehicle includes compressors compressing a CO₂ refrigerant; a heat exchanger cooling the compressed refrigerant; a cooling expansion valve expanding the cooled refrigerant; a refrigerant passage through which the refrigerant expanded by the cooling expansion valve is supplied to an air conditioner when the air conditioner is cooled; a refrigerant passage through which the refrigerant expanded by the cooling expansion valve is supplied to a motor when the motor is cooled; a battery refrigerant expansion valve expanding the refrigerant and injecting it into a battery case; a refrigerant passage and a refrigerant path switching valve through which the refrigerant having cooled the motor is supplied to the battery refrigerant expansion valve when the motor is cooled and a battery is cooled; and refrigerant passages through which the refrigerant having flowed through the air conditioner, the motor, and the battery is supplied to the compressor.

### TECHNICAL FIELD

The present disclosure relates to a temperature control system for an electric vehicle.

### BACKGROUND ART

Conventionally, an air-conditioning system having a thermal cycling circuit that is operated with a refrigerant containing CO₂ (hereinafter appropriately referred to as a CO₂ refrigerant) has been known. In addition, the following technique and cooling system have been studied. In the technique, the thermal cycling circuit in an in-vehicle air-conditioning system for an electric vehicle is thermally joined to a battery to cool or heat the battery (for example, see JP2011-68348A). In the cooling system, low-temperature CO₂ is circulated to the inside of a vehicle drive motor, an inverter, and the battery, each of which sealed in an individual package, in a cooling unit for direct cooling (for example, JP2009-107453A).

### SUMMARY

### Technical Problem

In recent years, it has been studied to adopt a CO₂ refrigerant also in an in-vehicle air-conditioning system. In this case, it is considered to use the CO₂ refrigerant, which is used in the thermal cycling circuit of the in-vehicle air-conditioning system, also to control temperatures of the motor and the battery.

However, the CO₂ refrigerant, which is depressurized by an expansion valve in the thermal cycling circuit of the air-conditioning system and reaches a low temperature, generally has a very high pressure of about 5 MPa. Accordingly, when it is attempted to directly cool a battery cell by causing such a high-pressure CO₂ refrigerant to flow around the cell, it is necessary to increase strength of a battery case and a cell structure, which increases battery weight and manufacturing cost. Meanwhile, in the case where the cell inside the battery is indirectly cooled via a heat exchanger, which is provided on an outer side of the battery case, by causing the high-pressure CO₂ refrigerant to flow into the heat exchanger, responsiveness of the temperature control is lower than that in the case of the direct cooling described above, which exhibits an expanded temperature variation range and promotes deterioration of the battery by the thermal cycling.

The present disclosure has been made to solve such a problem, and therefore has an object to provide a temperature control system for an electric vehicle capable of controlling a temperature of a battery with high responsiveness while achieving a weight reduction and improved efficiency of an entire system by using a CO₂ refrigerant that is common to a CO₂ refrigerant used for air conditioning of a cabin.

### Solution to Problem

In order to solve the above-described problem, the present disclosure provides a temperature control system for an electric vehicle that includes an air-conditioning unit for performing air conditioning, a drive motor, and a battery in which a cell is accommodated in a battery case, and includes: a compressor that compresses a refrigerant containing CO₂; a heat exchanger that cools the refrigerant compressed by the compressor; a first expansion valve that expands the refrigerant cooled by the heat exchanger; an air-conditioning cooling path, through which the refrigerant expanded by the first expansion valve is supplied to the air-conditioning unit when the air-conditioning unit is cooled; a motor cooling path, through which the refrigerant expanded by the first expansion valve is supplied to the motor when the motor is cooled; a second expansion valve that expands the refrigerant and injects it into the battery case; a battery cooling path, through which the refrigerant that has cooled the motor is supplied to the second expansion valve when the motor is cooled and the battery is cooled; and a collection path, through which the refrigerant that has flowed through the air-conditioning unit, the refrigerant that has flowed through the motor, and the refrigerant that has flowed through the battery are supplied to the compressor.

According to the present disclosure, since cooling of the air-conditioning unit, cooling of the motor, and cooling of the battery are performed by using the common refrigerant that contains CO₂, an overall configuration of the temperature control system can be made compact. In addition, when the motor is cooled and the battery is cooled, the refrigerant that has cooled the motor is supplied to the second expansion valve, and is then further expanded and injected into the battery case from the second expansion valve. Accordingly, it is possible to directly cool the cell with the refrigerant while strength of structures of the cell and the case of the battery is maintained at the same level as that in the related art. In this way, it is possible to control the temperature of the battery with high responsiveness without increasing weight of the battery or increasing manufacturing cost. Furthermore, it is not necessary to provide a separate heat exchanger only to cool the battery, and the weight reduction and improved efficiency of the entire temperature control system can thereby be achieved. As a result, even when it is applied to a lightweight sports car, superior handling and acceleration sensations can be achieved, which ensures a system that enhances driving enjoyment.

In the present disclosure, preferably, the compressor includes a first compressor compressing the refrigerant that has flowed through the battery; and a second compressor compressing the refrigerant that has flowed through the air-conditioning unit and the refrigerant that has flowed through the motor, and, when the motor is cooled and the battery is cooled, the second compressor further compresses the refrigerant compressed by the first compressor.

According to the present disclosure, the refrigerant that has been compressed by the first compressor after flowing through the battery, the refrigerant that has flowed through the air-conditioning unit, and the refrigerant that has flowed through the motor can be compressed by the second compressor. Thus, the second compressor, which is common for the compression of the refrigerant used to cool the air-conditioning unit, the motor, and the battery, can be used, and the overall configuration of the temperature control system can be made compact.

In the present disclosure, preferably, the temperature control system for an electric vehicle includes a battery heating path, through which the refrigerant compressed by the first compressor is supplied to the second expansion valve when the battery is heated.

According to the present disclosure, since the high-temperature refrigerant that is compressed by the first compressor is expanded and injected into the battery case from the second expansion valve, the cell can be directly heated by the refrigerant. In this way, it is possible to control the temperature of the battery with the high responsiveness without increasing the weight of the battery or increasing the manufacturing cost.

In the present disclosure, preferably, the second expansion valve includes a common rail that stores the refrigerant, and an injector that injects the refrigerant stored in the common rail into the battery case.

According to the present disclosure, a required amount of the refrigerant that corresponds to a heat generation amount and the temperature of the battery can be injected into the battery case from the injector at an appropriate pressure with a high degree of accuracy, it is possible to suppress a temperature fluctuation of the cell of the battery and thus to suppress deterioration of the battery by the thermal cycling.

In the present disclosure, preferably, the temperature control system for an electric vehicle includes an air-conditioning heating path, through which the refrigerant compressed by the compressor is supplied to the air-conditioning unit when the air-conditioning unit is heated.

According to the present disclosure, the high-temperature, high-pressure refrigerant that is compressed by the compressor is supplied to the air-conditioning unit via the air-conditioning heating path, and the air-conditioning unit can thereby be heated.

### Advantageous Effects

According to the temperature control system for an electric vehicle in the present disclosure, it is possible to control the temperature of the battery with the high responsiveness while achieving the weight reduction and the improved efficiency of the entire system by the CO₂ refrigerant that is common to the CO₂ refrigerant used for air conditioning of the cabin.

### BRIEF DESCRIPTION OF DRAWINGS

FIG. 1 is a schematic configuration view of a vehicle to which a temperature control system for an electric vehicle according to an embodiment of the present disclosure is applied.

FIG. 2 is a schematic configuration view of the temperature control system for the electric vehicle according to the embodiment of the present disclosure.

FIG. 3 is a block diagram illustrating an electrical configuration of the temperature control system for the electric vehicle according to the embodiment of the present disclosure.

FIG. 4 is a flowchart of control that is executed by the temperature control system for the electric vehicle according to the embodiment of the present disclosure.

FIG. 5 is a table illustrating an air-conditioning/battery coordination control pattern that corresponds to a combination of an air-conditioning request and a battery temperature control request for the temperature control system for the electric vehicle according to the embodiment of the present disclosure.

FIG. 6 includes a P-H diagram and a P-T diagram of thermal cycles of a motor, an air conditioner, and a battery as well as a view illustrating a flow of a refrigerant in an air-conditioning/battery coordination control pattern 1-a of the temperature control system for the electric vehicle according to the embodiment of the present disclosure.

FIG. 7 includes a P-H diagram and a P-T diagram of the thermal cycles of the motor, the air conditioner, and the battery as well as a view illustrating the flow of the refrigerant in an air-conditioning/battery coordination control pattern 2-a of the temperature control system for the electric vehicle according to the embodiment of the present disclosure.

FIG. 8 includes a P-H diagram and a P-T diagram of the thermal cycles of the motor, the air conditioner, and the battery as well as a view illustrating the flow of the refrigerant in an air-conditioning/battery coordination control pattern 2-b of the temperature control system for the electric vehicle according to the embodiment of the present disclosure.

FIG. 9 includes a P-H diagram and a P-T diagram of the thermal cycles of the motor and the battery as well as a view illustrating the flow of the refrigerant in an air-conditioning/battery coordination control pattern 3-a of the temperature control system for the electric vehicle according to the embodiment of the present disclosure.

FIG. 10 includes a P-H diagram and a P-T diagram of the thermal cycles of the motor and the battery as well as a view illustrating the flow of the refrigerant in an air-conditioning/battery coordination control pattern 3-b of the temperature control system for the electric vehicle according to the embodiment of the present disclosure.

FIG. 11 includes a P-H diagram and a P-T diagram of the thermal cycles of the motor, the air conditioner, and the battery as well as a view illustrating the flow of the refrigerant in an air-conditioning/battery coordination control pattern 4-a of the temperature control system for the electric vehicle according to the embodiment of the present disclosure.

FIG. 12 includes a P-H diagram and a P-T diagram of the thermal cycles of the motor, the air conditioner, and the battery as well as a view illustrating the flow of the refrigerant in an air-conditioning/battery coordination control pattern 4-b of the temperature control system for the electric vehicle according to the embodiment of the present disclosure.

### DESCRIPTION OF EMBODIMENTS

A description will hereinafter be made on a temperature control system for an electric vehicle according to an embodiment of the present disclosure with reference to the accompanying drawings.

### Overall Configuration

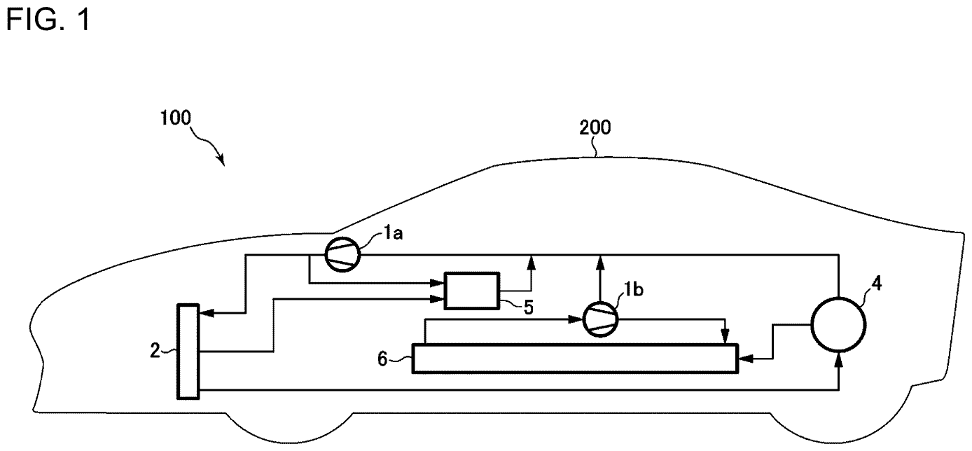

First, a description will be made on an overall configuration of the temperature control system for the electric vehicle according to a present embodiment with reference to FIG. 1. FIG. 1 is a schematic configuration view of a vehicle to which the temperature control system for the electric vehicle according to the present embodiment is applied.

As illustrated in FIG. 1, an electric vehicle 200 includes a temperature control system 100 having a thermal cycling circuit that is operated with a refrigerant containing CO₂, a motor 4 for driving the electric vehicle 200, an air conditioner 5 that performs air conditioning in the electric vehicle 200, and a battery 6 that supplies electric power to the motor 4. The temperature control system 100 mainly includes a high-pressure compressor 1a and a low-pressure compressor 1b for compressing the refrigerant, and a heat exchanger 2 for cooling the refrigerant that is compressed by the high-pressure compressor 1a. The air conditioner 5 is an example of an air-conditioning unit in the present disclosure.

The temperature control system 100 circulates a CO₂ refrigerant (hereinafter may also simply referred to as a “refrigerant”) as a natural refrigerant. Typically, the CO₂ refrigerant is a refrigerant in which refrigerant oil such as a polyalkylene glycol (PAG), an additive, and the like are contained in CO₂. In order to use such a CO₂ refrigerant, the high-pressure compressor 1a is configured to compress the refrigerant to an extremely high pressure (for example, 11 MPa). The motor 4 uses the refrigerant, which has been compressed by the high-pressure compressor 1a and cooled by the heat exchanger 2, to cool a rotor and a stator. Furthermore, the motor 4 is configured to lubricate a slide bearing, which supports a rotation shaft, with the refrigerant. There is a case where the refrigerant that has been used to cool the motor 4 is thereafter used to cool the battery 6. The refrigerant that has been compressed by the high-pressure compressor 1a or the refrigerant that has been cooled by the heat exchanger 2 after being compressed is used for air conditioning in the air conditioner 5. Meanwhile, there is a case where the refrigerant that has been compressed by the low-pressure compressor 1b is used to increase a temperature of the battery 6.

### Configuration of Temperature Control System

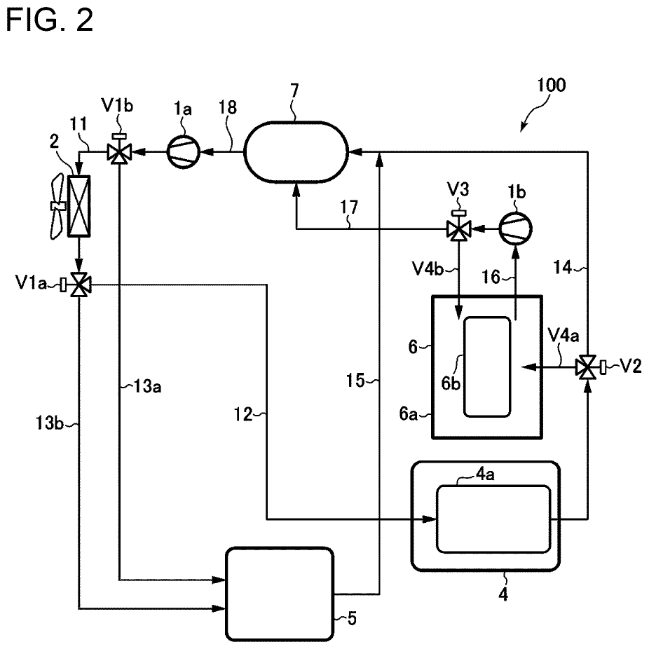

Next, a specific description will be made on the temperature control system 100 according to the present embodiment with reference to FIG. 2. FIG. 2 is a schematic configuration view of the temperature control system 100 according to the present embodiment.

The temperature control system 100 constitutes the thermal cycling circuit that circulates the CO₂ refrigerant described above, and includes, in addition to the high-pressure compressor 1a, the low-pressure compressor 1b, and the heat exchanger 2 described above: a reservoir tank 7 for temporarily storing the refrigerant to ensure stable circulation of the refrigerant in the thermal cycling circuit; refrigerant passages 11 to 18, through each of which the refrigerant flows; a cooling expansion valve V1a (a first expansion valve) that expands and depressurizes the refrigerant; a temperature increase valve V1b that switches a passage of the high-temperature, high-pressure refrigerant; a refrigerant path switching valve V2 that switches a path of the refrigerant that has been used to cool the motor 4; a refrigerant path switching valve V3 that switches the path of the refrigerant that has flowed out from the battery 6; and battery refrigerant expansion valves V4a, V4b, each of which expands and depressurizes the refrigerant to inject it into the battery 6.

The high-pressure compressor 1a (a second compressor) compresses the refrigerant that has flowed through the motor 4 or the air conditioner 5 and has been stored in the reservoir tank 7, or that has flowed through the battery 6, has been compressed by the low-pressure compressor 1b, and has been stored in the reservoir tank 7. The low-pressure compressor 1b (a first compressor) compresses the refrigerant that has flowed through the battery 6. The high-pressure compressor 1a increases a pressure P2 of the refrigerant to a pressure P1 (the pressure P1>the pressure P2), and the low-pressure compressor 1b increases a pressure P3 of the refrigerant to the pressure P2 (the pressure P2 >the pressure P3). In one example, the pressure P1 is about 11 MPa, the pressure P2 is about 5 MPa or 0.3 MPa, and the pressure P3 is about 0.1 MPa.

The heat exchanger 2 cools the refrigerant that has been compressed by the high-pressure compressor 1a.

The motor 4 is cooled by the temperature control system 100. More specifically, the refrigerant is compressed by the high-pressure compressor 1a, is cooled through the heat exchanger 2 via the refrigerant passage 11, is further expanded and cooled to a low temperature by the cooling expansion valve V1a, and is then supplied to the motor 4 from the refrigerant passage 12 (a motor cooling path). The refrigerant that is supplied to the motor 4 cools the motor 4 by absorbing heat when flowing through an internal structure 4a of the motor 4, for example, between the rotor and the stator, a bearing that supports the rotation shaft coupled to the rotor, or the like, then returns to the high-pressure compressor 1a through the refrigerant passage 14, the reservoir tank 7, and the refrigerant passage 18 (a collection path), and is compressed again. When the battery 6 is cooled, the refrigerant that has flowed through the motor 4 is supplied to the battery refrigerant expansion valve V4a through the refrigerant passage 14 and the refrigerant path switching valve V2 (a battery cooling path), and is injected into the battery 6 from the battery refrigerant expansion valve V4a.

The air conditioner 5 is cooled or heated by the temperature control system 100. When the air conditioner 5 is cooled, the refrigerant is compressed by the high-pressure compressor 1a, is cooled through the heat exchanger 2 via the refrigerant passage 11, is further expanded and cooled to the lower temperature than air in a cabin by the cooling expansion valve V1a, and is then supplied to the air conditioner 5 from a refrigerant passage 13b (an air-conditioning cooling path). The refrigerant that is supplied to the air conditioner 5 cools the air flowing into the cabin by absorbing the heat when flowing through an in-vehicle heat exchanger in the air conditioner 5, then returns to the high-pressure compressor 1a through the refrigerant passage 15, the reservoir tank 7, and the refrigerant passage 18, and is compressed again.

When the air conditioner 5 is heated, the refrigerant is compressed by the high-pressure compressor 1a, and is expanded by the temperature increase valve V1b. However, the refrigerant at the higher temperature than the air in the cabin is supplied from a refrigerant passage 13a (an air-conditioning heating path) to the air conditioner 5. The refrigerant that is supplied to the air conditioner 5 heats the air flowing into the cabin by radiating the heat when flowing through the in-vehicle heat exchanger in the air conditioner 5, then returns to the high-pressure compressor 1a through the refrigerant passage 15, the reservoir tank 7, and the refrigerant passage 18, and is compressed again.

In the present embodiment, the battery 6 includes a battery case 6a and a cell 6b that is accommodated in the battery case 6a. The battery case 6a is sealed, and it is configured that the refrigerant is supplied to the inside of the battery case 6a via the battery refrigerant expansion valve V4a or V4b and that the refrigerant is discharged from the battery case 6a via the refrigerant passage 16. The battery refrigerant expansion valves V4a, V4b (second expansion valves) each expand the refrigerant and inject it into the battery case 6a. It is desired that each of the battery refrigerant expansion valves V4a, V4b can control a pressure and a flow rate of the refrigerant to be injected, and a common rail and an injector are used therefor, for example. The common rail stores the refrigerant that is supplied through the refrigerant path switching valve V2 or V3, and the injector injects the refrigerant stored in the common rail into the battery case 6a. In this case, the battery refrigerant expansion valves V4a, V4b may be configured to share the single common rail and the single injector.

When the battery 6 is cooled, the refrigerant that has cooled the motor 4 is injected into the battery case 6a by the battery refrigerant expansion valve V4a via the refrigerant passage 14 and the refrigerant path switching valve V2. At this time, the refrigerant is expanded and cooled to the lower temperature than the cell 6b, and the refrigerant injected into the battery case 6a cools the cell 6b by absorbing the heat when flowing around the cell 6b, and flows out from the battery case 6a through the refrigerant passage 16. In this way, the cell 6b is directly cooled by the refrigerant. Thereafter, the refrigerant is compressed by the low-pressure compressor 1b, then returns to the high-pressure compressor 1a through the refrigerant path switching valve V3, the refrigerant passage 17, the reservoir tank 7, and the refrigerant passage 18, and is compressed again.

When the battery 6 is heated, the refrigerant is not supplied from the motor 4. In this case, the refrigerant that has flowed out from the battery case 6a flows through the refrigerant passage 16, is then compressed by the low-pressure compressor 1b, and is injected into the battery case 6a by the battery refrigerant expansion valve V4b via the refrigerant path switching valve V3 (a battery heating path). At this time, although being expanded, the refrigerant is heated to a higher temperature than the cell 6b, and the refrigerant injected into the battery case 6a heats the cell 6b by radiating the heat when flowing around the cell 6b, then returns to the low-pressure compressor 1b through the refrigerant passage 16, and is compressed again. In this way, the cell 6b is directly heated by the refrigerant.

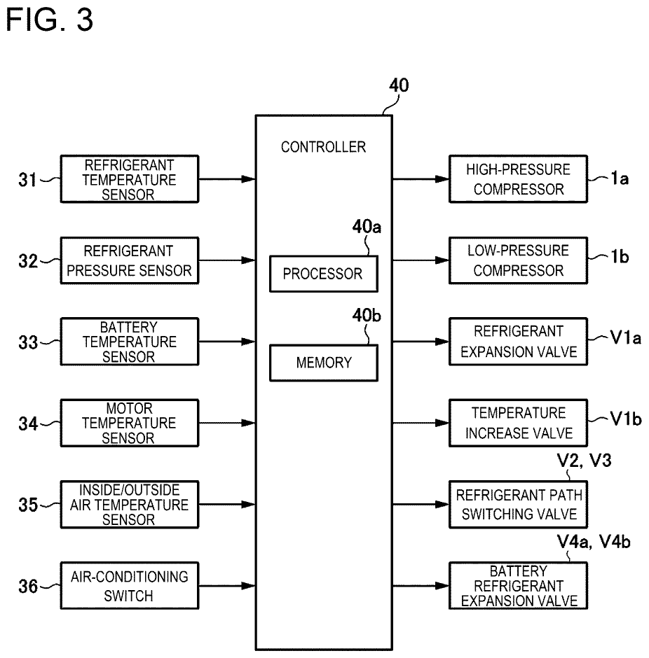

Next, a description will be made on an electrical configuration of the temperature control system 100 according to the present embodiment with reference to FIGS. 2 and 3. FIG. 3 is a block diagram illustrating the electrical configuration of the temperature control system 100 according to the present embodiment.

As illustrated in FIG. 3, the temperature control system 100 includes a controller 40 that is configured to execute various types of control in the system. The controller 40 is implemented by a computer that includes one or more processors 40a (typically central processing units (CPUs)); and memory 40b, such as read-only memory (ROM) and random access memory (RAM), that stores various programs (including a basic control program such as an operating system (OS) and an application program activated on the OS to implement a particular function) interpretively executed on the processor 40a and various types of data.

The temperature control system 100 also includes a refrigerant temperature sensor 31 that detects the temperature of the refrigerant flowing through the refrigerant passages 11 to 18, a refrigerant pressure sensor 32 that detects the pressure of the refrigerant, a battery temperature sensor 33 that detects the temperature of the battery 6, a motor temperature sensor 34 that detects a temperature of the motor 4, an inside/outside air temperature sensor 35 that detects air temperatures inside and outside the cabin of the electric vehicle 200, and an air-conditioning switch 36 that accepts an operation input to the air conditioner 5. A plurality of each of the refrigerant temperature sensor 31 and the refrigerant pressure sensor 32 can be provided at appropriate positions in the refrigerant passages 11 to 18.

The controller 40 outputs control signals to the high-pressure compressor 1a, the low-pressure compressor 1b, the cooling expansion valve V1a, the temperature increase valve V1b, the refrigerant path switching valves V2, V3, and the battery refrigerant expansion valves V4a, V4b on the basis of signals input from the sensors 31 to 35 and the air-conditioning switch 36 described above, and controls these.

### Control

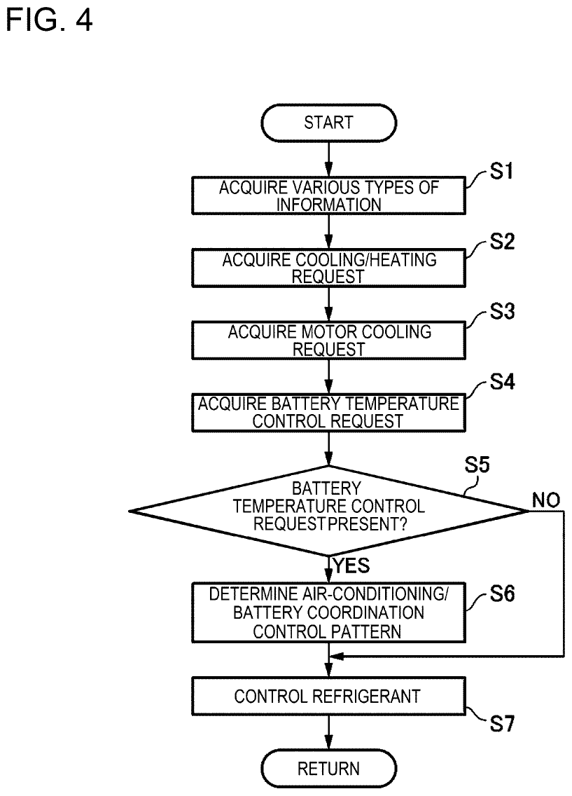

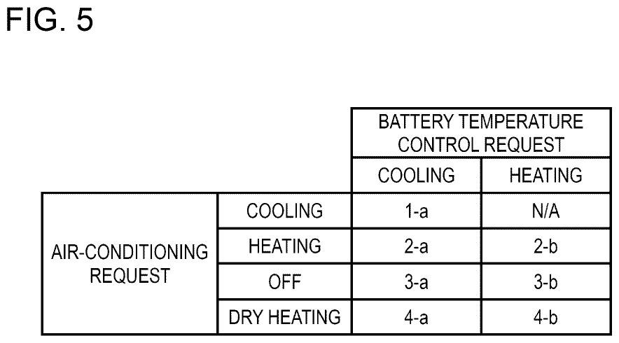

Next, a description will be made on the control that is executed by the controller 40 in the present embodiment with reference to FIGS. 4 and 5. FIG. 4 is a flowchart of the control that is executed by the temperature control system 100 for the electric vehicle 200 according to the embodiment of the present disclosure, and FIG. 5 is a table illustrating an air-conditioning/battery coordination control pattern that corresponds to a combination of an air-conditioning request and a battery temperature control request for the temperature control system 100 for the electric vehicle 200.

The control illustrated in FIG. 4 is repeatedly executed by the controller 40 at a predetermined cycle during operation of the temperature control system 100. More specifically, the processor 40a in the controller 40 reads the program that is stored in the memory 40b to execute the program, and thereby realizes the control illustrated in the flowchart in FIG. 4.

When the control is started, in step S1, the controller 40 acquires various types of information such as detection values detected by the sensors 31 to 35 described above and an operation value input to the air-conditioning switch 36.

Next, in step S2, based on the information acquired in step S1, the controller 40 acquires a cooling/heating request for the air conditioner 5, that is, a required value of cooling capacity or heating capacity of the air conditioner 5 (for example, the flow rate of the refrigerant that is supplied to the air conditioner 5). For example, the required value of the cooling capacity or the heating capacity of the air conditioner 5 is acquired according to a difference between a temperature set by the air-conditioning switch 36 and a temperature in the cabin.

Next, in step S3, based on the information acquired in step S1, the controller 40 acquires a cooling request for the motor 4, that is, a required value of cooling capacity for the motor 4 (for example, the flow rate of the refrigerant that is supplied to the motor 4). For example, the required value of the cooling capacity for the motor 4 is acquired according to a difference between a reference temperature, which is set in advance, and the temperature of the motor 4 detected by the motor temperature sensor 34.

Next, in step S4, based on the information acquired in step S1, the controller 40 acquires a temperature control request for the battery 6, that is, a cooling or heating request for the battery 6. More specifically, in the case where a temperature increase of the battery 6 is predicted in a situation where cooling of the battery 6 is required, for example, a situation where the electric power is supplied from the battery 6 to drive the motor 4 or a situation where regenerative power is supplied from the motor 4 to the battery 6, the controller 40 acquires a required value of cooling capacity for the battery 6 (for example, an injection amount of the refrigerant that is injected from the battery refrigerant expansion valve V4a) according to a magnitude of the supplied electric power output from the battery 6 or a magnitude of the regenerative power received by the battery 6. Meanwhile, in the case where the temperature of the battery 6, which is detected by the battery temperature sensor 33, is lower than a reference temperature, which is set in advance, in a situation where heating of the battery 6 is required, for example, a situation where the temperature of the battery 6 has to be increased to a charging temperature, which is higher than a room temperature, for charging of the electric vehicle 200 while the electric vehicle 200 is stopped, or during travel of the electric vehicle 200, a required value of heating capacity for the battery 6 (for example, an injection amount of the refrigerant that is injected from the battery refrigerant expansion valve V4b) is acquired.

Next, in step S5, the controller 40 determines whether the temperature control request for the battery 6 is present in step S4. As a result, if the temperature control request for the battery 6 is acquired (step S5: YES), that is, if the required value of the cooling capacity or the heating capacity for the battery 6 is acquired in step S4, the processing proceeds to step S6, and the controller 40 determines the air-conditioning/battery coordination control pattern. In the present embodiment, the air-conditioning/battery coordination control pattern represents a control pattern of the temperature control system 100 that corresponds to a combination of the cooling/heating request for the air conditioner 5 and the temperature control request for the battery 6. For example, a table of the air-conditioning/battery coordination control pattern as illustrated in FIG. 5 is stored in the memory 40b in advance. A content of each of control patterns 1-a, 2-a, 2-b, 3-a, 3-b, 4-a, and 4-b illustrated in the table in FIG. 5 will be described below. The controller 40 acquires, from the memory 40b, the air-conditioning/battery coordination control pattern that corresponds to the cooling/heating request for the air conditioner 5 acquired in step S2 and the temperature control request for the battery 6 acquired in step S4.

After determining the air-conditioning/battery coordination control pattern in step S6, or if it is determined in step S5 that the temperature control request for the battery 6 is absent (that is, neither cooling nor heating of the battery 6 is required) in step S4 (step S5: NO), in step S7, the controller 40 controls the refrigerant that flows through the temperature control system 100 on the basis of the cooling/heating request for the air conditioner 5 acquired in step S2, the cooling request for the motor 4 acquired in step S3, the temperature control request for the battery 6 acquired in step S4, and the air-conditioning/battery coordination control pattern determined in step S6 if the temperature control request for the battery 6 is present (step S7). That is, operation of each of the high-pressure compressor 1a, the low-pressure compressor 1b, the cooling expansion valve V1a, the temperature increase valve V1b, the refrigerant path switching valves V2, V3, and the battery refrigerant expansion valves V4a, V4b is controlled in a manner to correspond to each of the required value of the cooling capacity or the heating capacity of the air conditioner 5, the required value of the cooling capacity for the motor 4, the required value of the cooling capacity or the heating capacity for the battery 6, and the air-conditioning/battery coordination control pattern. After step S7, the controller 40 terminates the control.

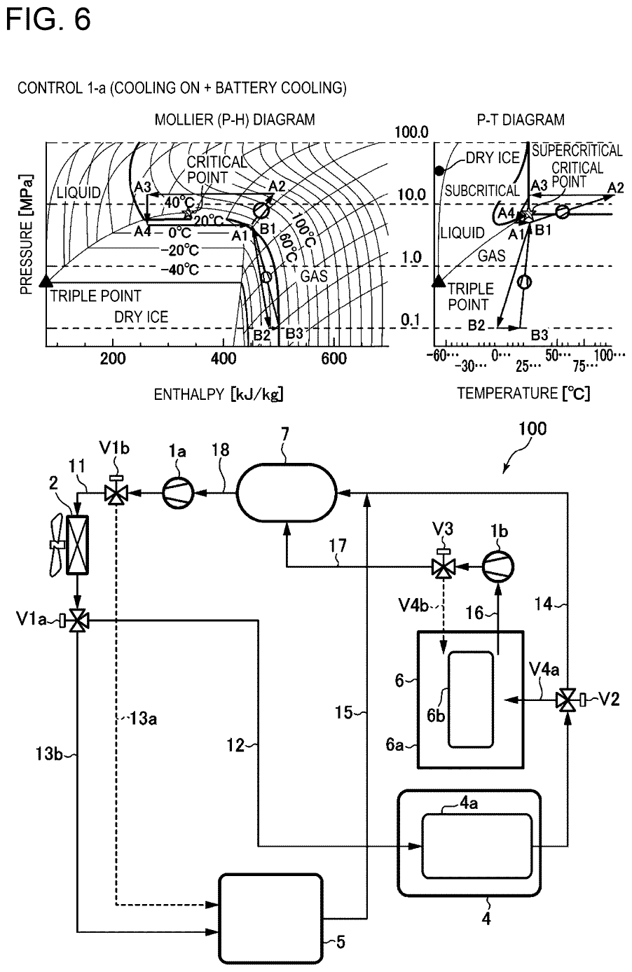

Next, a description will be made on the content of each of the control patterns 1-a, 2-a, 2-b, 3-a, 3-b, 4-a, and 4-b illustrated in the table of FIG. 5 with reference to FIGS. 6 to 12. An upper side of each of FIGS. 6 to 12 illustrates a P-H diagram and a P-T diagram of a cooling or heating cycle of the air conditioner 5 and the battery 6 in the respective control pattern, and a lower side illustrates the thermal cycling circuit of the temperature control system 100 in the respective control pattern. In the thermal cycling circuit illustrated in each of FIGS. 6 to 12, solid lines indicate the refrigerant passages through which the refrigerant flows, and broken lines indicate the refrigerant passages through which the refrigerant does not flow.

### Air-Conditioning/Battery Coordination Control Pattern 1-a

FIG. 6 includes a P-H diagram and a P-T diagram of cooling cycles of the motor 4, the air conditioner 5, and the battery 6 as well as a view illustrating the flow of the refrigerant in the air-conditioning/battery coordination control pattern 1-a. As illustrated in FIG. 5, the air-conditioning/battery coordination control pattern 1-a is an example of the control pattern when the cooling request for the air conditioner 5 is present, and the cooling request for the battery 6 is present.

In the air-conditioning/battery coordination control pattern 1-a, as illustrated in FIG. 6, in the temperature control system 100, a thermal cycling circuit for cooling the motor 4, a thermal cycling circuit for cooling by the air conditioner 5, and a thermal cycling circuit for cooling the battery 6 by using the refrigerant that has cooled the motor 4 are formed.

Of these, in the thermal cycling circuit for cooling the motor 4, the refrigerant is compressed by the high-pressure compressor 1a into the high temperature and the high pressure (in the example of FIG. 6, about 120° C. and 11 MPa, and a point A2 in the P-H diagram and the P-T diagram), is then cooled through the heat exchanger 2 via the refrigerant passage 11 (in the example of FIG. 6, about 30° C. and a point A3 in the P-H diagram and the P-T diagram), is further expanded isenthalpically by the cooling expansion valve V1a into the low temperature (in the example of FIG. 6, about 15° C. and 5 MPa, and a point A4 in the P-H diagram and the P-T diagram), and is supplied from the refrigerant passage 12 to the motor 4. The refrigerant that is supplied to the motor 4 cools the motor 4 by absorbing the heat when flowing through the stator, the rotor, the bearing, and the like of the motor 4, then returns to the high-pressure compressor 1a through the refrigerant passage 14, the reservoir tank 7, and the refrigerant passage 18, and is compressed again.

Meanwhile, in the thermal cycling circuit for cooling by the air conditioner 5, the refrigerant is compressed by the high-pressure compressor 1a into the high temperature and the high pressure (in the example of FIG. 6, about 120° C. and 11 MPa, and the point A2 in the P-H diagram and the P-T diagram), is then cooled through the heat exchanger 2 via the refrigerant passage 11 (in the example of FIG. 6, about 30° C. and the point A3 in the P-H diagram and the P-T diagram), is further expanded isenthalpically by the cooling expansion valve V1a into the low temperature (in the example of FIG. 6, about 15° C. and 5 MPa, and the point A4 in the P-H diagram and the P-T diagram), and is supplied from the refrigerant passage 13b to the air conditioner 5. The refrigerant that is supplied to the air conditioner 5 cools the air flowing into the cabin by absorbing the heat when flowing through the in-vehicle heat exchanger in the air conditioner 5, then returns to the high-pressure compressor 1a through the refrigerant passage 15, the reservoir tank 7, and the refrigerant passage 18 (in the example of FIG. 6, about 30° C. and 5 MPa, and a point A1 in the P-H diagram and the P-T diagram), and is compressed again.

In the thermal cycling circuit for cooling the battery 6, the refrigerant that has cooled the motor 4 (in the example of FIG. 6, about 30° C. and 5 MPa, and the point A1 in the P-H diagram and the P-T diagram) is supplied to the battery refrigerant expansion valve V4a via the refrigerant passage 14 and the refrigerant path switching valve V2 (in the example of FIG. 6, about 30° C. and 5 MPa, and a point B1 in the P-H diagram and the P-T diagram), and is injected into the battery case 6a by the battery refrigerant expansion valve V4a. At this time, the refrigerant is expanded into the lower temperature than the cell 6b (in the example of FIG. 6, about 0° C. and 0.1 MPa, and a point B2 in the P-H diagram and the P-T diagram), and the refrigerant that has been injected into the battery case 6a cools the cell 6b by absorbing the heat when flowing around the cell 6b, and flows out from the battery case 6a through the refrigerant passage 16 (in the example of FIG. 6, about 20° C. and 0.1 MPa, and a point B3 in the P-H diagram and the P-T diagram). Thereafter, the refrigerant is compressed by the low-pressure compressor 1b (in the example of FIG. 6, about 30° C. and 5 MPa, and the point B1 in the P-H diagram and the P-T diagram), then returns to the high-pressure compressor 1a through the refrigerant path switching valve V3, the refrigerant passage 17, the reservoir tank 7, and the refrigerant passage 18, and is compressed again (in the example of FIG. 6, about 120° C. and 11 MPa, and the point A2 in the P-H diagram and the P-T diagram).

### Air-Conditioning/Battery Coordination Control Pattern 2-a

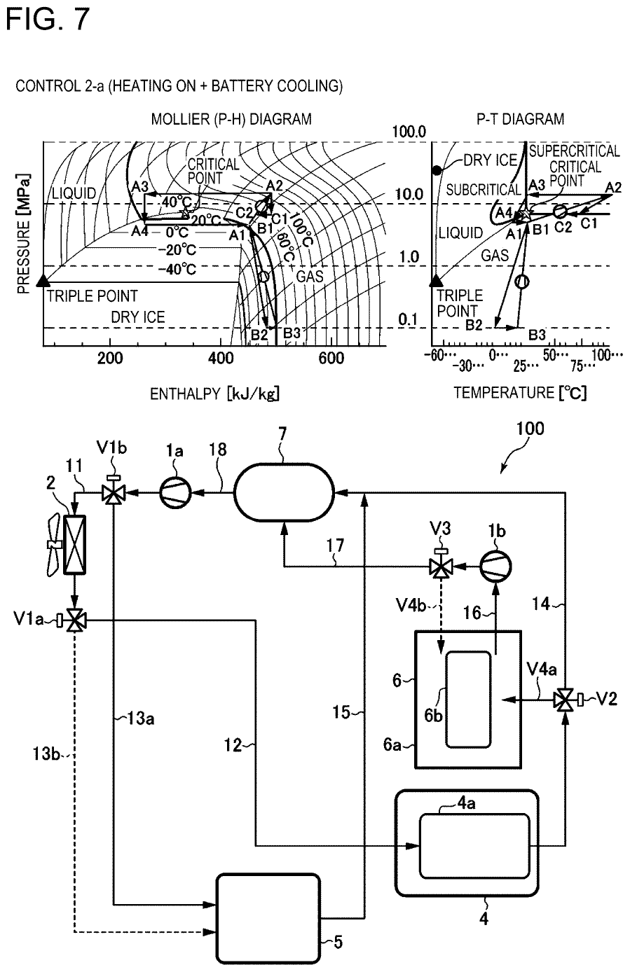

FIG. 7 includes a P-H diagram and a P-T diagram of the cooling cycle of the motor 4, the heating cycle of the air conditioner 5, and the cooling cycle of the battery 6 as well as a view illustrating the flow of the refrigerant in the air-conditioning/battery coordination control pattern 2-a. As illustrated in FIG. 5, the air-conditioning/battery coordination control pattern 2-a is an example of the control pattern when the heating request for the air conditioner 5 is present, and the cooling request for the battery 6 is present.

In the air-conditioning/battery coordination control pattern 2-a, as illustrated in FIG. 7, in the temperature control system 100, the thermal cycling circuit for cooling the motor 4, a thermal cycling circuit for heating by the air conditioner 5, and the thermal cycling circuit for cooling the battery 6 by using the refrigerant that has cooled the motor 4 are formed. Of these, the thermal cycling circuit for cooling the motor 4 and the thermal cycling circuit for cooling the battery 6 are the same as those in the air-conditioning/battery coordination control pattern 1-a.

In the thermal cycling circuit for heating by the air conditioner 5, the refrigerant is compressed by the high-pressure compressor 1a into the high temperature and the high pressure (in the example of FIG. 7, about 120° C. and 11 MPa, and the point A2 in the P-H diagram and the P-T diagram), and the refrigerant that is expanded by the temperature increase valve V1b but is at the higher temperature than the air in the cabin (in the example of FIG. 7, about 75° C. and 7 MPa, and a point C1 in the P-H diagram and the P-T diagram), is supplied to the air conditioner 5 from the refrigerant passage 13a. The refrigerant that is supplied to the air conditioner 5 heats the air flowing into the cabin by radiating the heat when flowing through the in-vehicle heat exchanger in the air conditioner 5, then returns to the high-pressure compressor 1a through the refrigerant passage 15, the reservoir tank 7, and the refrigerant passage 18 (in the example of FIG. 7, about 60° C. and 7 MPa, and a point C2 in the P-H diagram and the P-T diagram), and is compressed again.

### Air-Conditioning/Battery Coordination Control Pattern 2-b

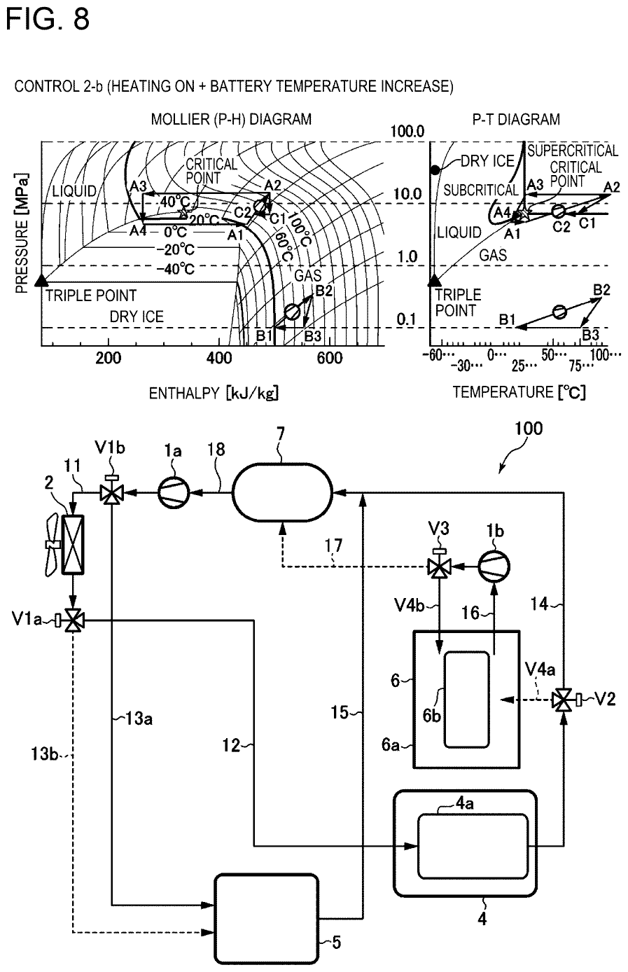

FIG. 8 includes a P-H diagram and a P-T diagram of the cooling cycle of the motor 4 and the heating cycle of the air conditioner 5 and the battery 6 as well as a view illustrating the flow of the refrigerant in the air-conditioning/battery coordination control pattern 2-b. As illustrated in FIG. 5, the air-conditioning/battery coordination control pattern 2-b is an example of the control pattern when the heating request for the air conditioner 5 is present, and the heating request for the battery 6 is present.

In the air-conditioning/battery coordination control pattern 2-b, as illustrated in FIG. 8, in the temperature control system 100, the thermal cycling circuit for cooling the motor 4, the thermal cycling circuit for heating by the air conditioner 5, and a thermal cycling circuit for heating the battery 6 independently of the motor 4 are formed. Of these, the thermal cycling circuit for cooling the motor 4 is the same as that in the air-conditioning/battery coordination control pattern 1-a, and the thermal cycling circuit for heating by the air conditioner 5 is the same as that in the air-conditioning/battery coordination control pattern 2-a.

In the thermal cycling circuit for heating the battery 6, the refrigerant is compressed by the low-pressure compressor 1b into the high temperature (in the example of FIG. 8, about 100° C. and 0.3 MPa, and the point B2 in the P-H diagram and the P-T diagram), is then supplied to the battery refrigerant expansion valve V4b via the refrigerant path switching valve V3, and is injected into the battery case 6a by the battery refrigerant expansion valve V4b. At this time, the refrigerant is expanded but is at the higher temperature than the cell 6b (in the example of FIG. 8, about 80° C. and 0.1 MPa, and the point B3 in the P-H diagram and the P-T diagram), and the refrigerant that has been injected into the battery case 6a heats the cell 6b by radiating the heat when flowing around the cell 6b, then returns to the low-pressure compressor 1b through the refrigerant passage 16 (in the example of FIG. 8, about 20° C. and 0.1 MPa, and the point B1 in the P-H diagram and the P-T diagram).

### Air-Conditioning/Battery Coordination Control Pattern 3-a

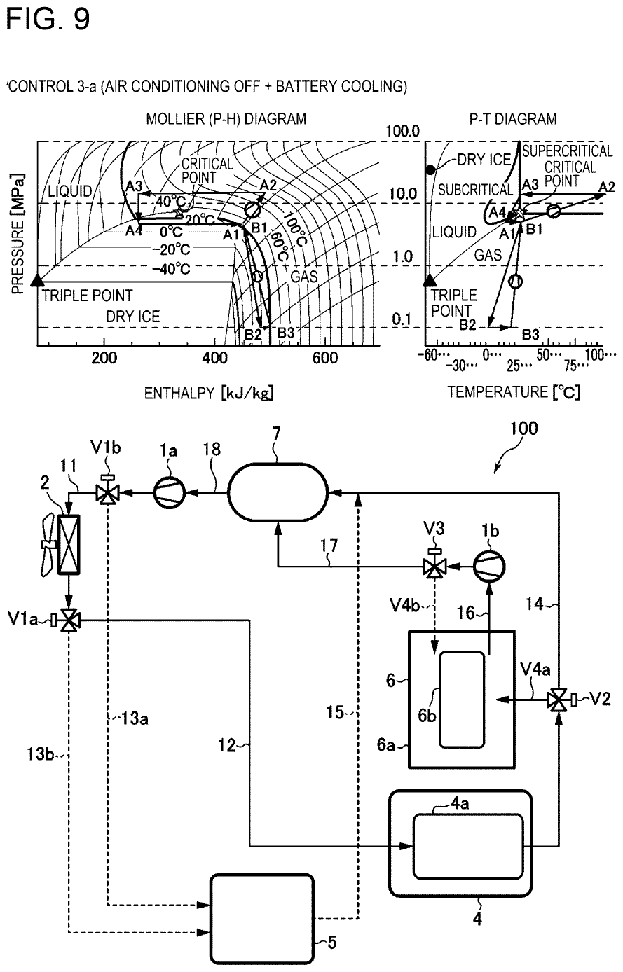

FIG. 9 includes a P-H diagram and a P-T diagram of cooling cycles of the motor 4 and the battery 6 as well as a view illustrating the flow of the refrigerant in the air-conditioning/battery coordination control pattern 3-a. As illustrated in FIG. 5, the air-conditioning/battery coordination control pattern 3-a is an example of the control pattern when the cooling/heating request for the air conditioner 5 is absent (that is, the air conditioner 5 is OFF), and the cooling request for the battery 6 is present.

In the air-conditioning/battery coordination control pattern 3-a, as illustrated in FIG. 9, in the temperature control system 100, the thermal cycling circuit for cooling the motor 4 and the thermal cycling circuit for cooling the battery 6 by using the refrigerant that has cooled the motor 4 are formed. The thermal cycling circuit for cooling the motor 4 and the thermal cycling circuit for cooling the battery 6 are the same as those in the air-conditioning/battery coordination control pattern 1-a.

### Air-Conditioning/Battery Coordination Control Pattern 3-b

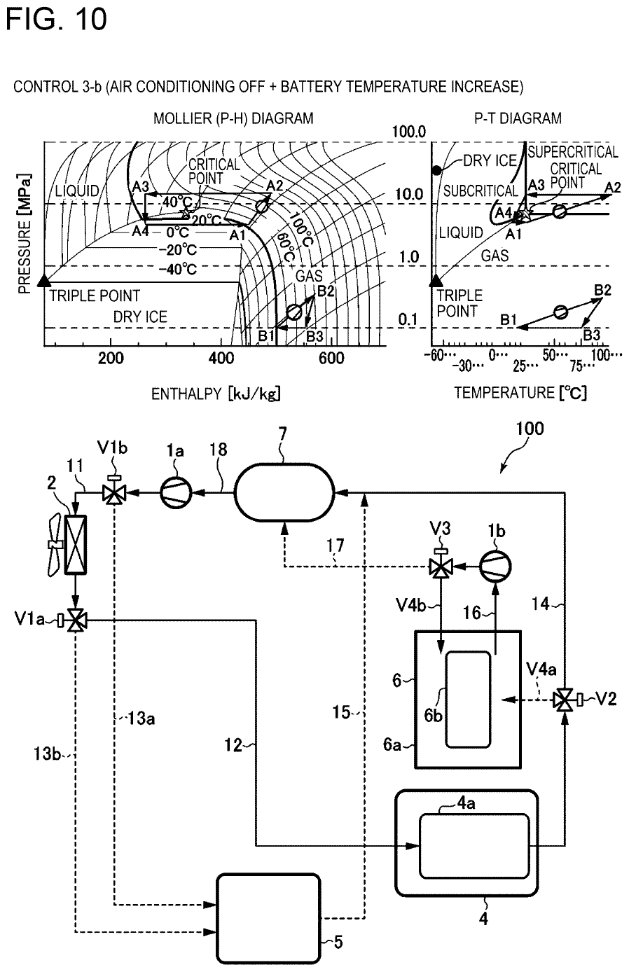

FIG. 10 includes a P-H diagram and a P-T diagram of the cooling cycle of the motor 4 and the heating cycle of the battery 6 as well as a view illustrating the flow of the refrigerant in the air-conditioning/battery coordination control pattern 3-b. As illustrated in FIG. 5, the air-conditioning/battery coordination control pattern 3-b is an example of the control pattern when the cooling/heating request for the air conditioner 5 is absent (that is, the air conditioner 5 is OFF), and the heating request for the battery 6 is present.

In the air-conditioning/battery coordination control pattern 3-b, as illustrated in FIG. 10, in the temperature control system 100, the thermal cycling circuit for cooling the motor 4 and the thermal cycling circuit for heating the battery 6 independently of the motor 4 are formed. Of these, the thermal cycling circuit for cooling the motor 4 is the same as that in the air-conditioning/battery coordination control pattern 1-a, and the thermal cycling circuit for heating the battery 6 is the same as that in the air-conditioning/battery coordination control pattern 2-b.

### Air-Conditioning/Battery Coordination Control Pattern 4-a

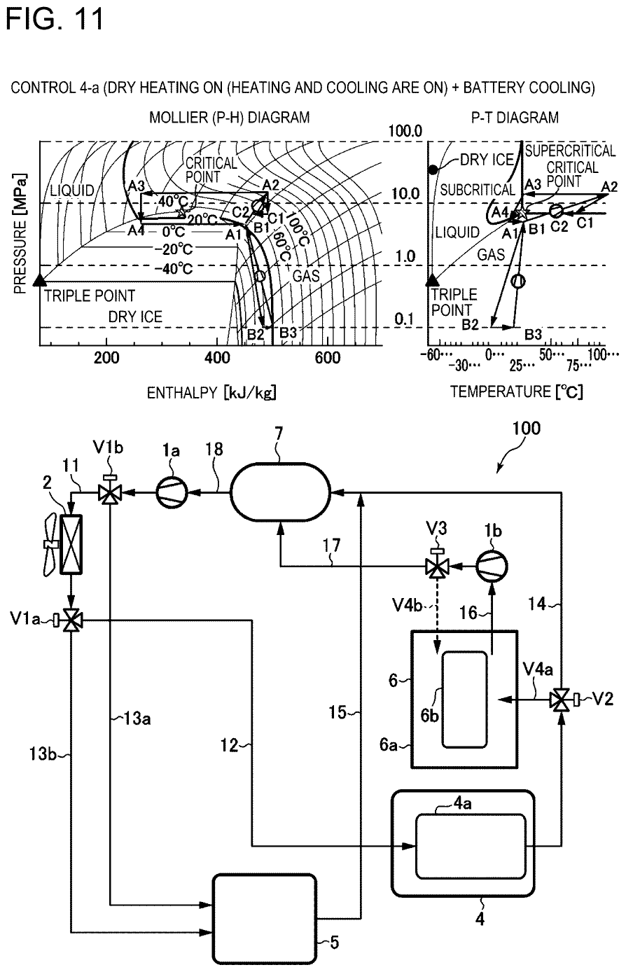

FIG. 11 includes a P-H diagram and a P-T diagram of the cooling cycle of the motor 4, a heating and cooling cycle of the air conditioner 5, and the cooling cycle of the battery 6 as well as a view illustrating the flow of the refrigerant in the air-conditioning/battery coordination control pattern 4-a. As illustrated in FIG. 5, the air-conditioning/battery coordination control pattern 4-a is an example of the control pattern when a dry heating request for the air conditioner 5 is present, and the cooling request for the battery 6 is present. In the present embodiment, dry heating refers to operation in which cooling and heating are simultaneously operated in order to heat the air in the cabin while dehumidifying the air.

In the air-conditioning/battery coordination control pattern 4-a, as illustrated in FIG. 11, in the temperature control system 100, the thermal cycling circuit for cooling the motor 4, a thermal cycling circuit for dry heating by the air conditioner 5, and the thermal cycling circuit for cooling the battery 6 by using the refrigerant that has cooled the motor 4 are formed. Of these, the thermal cycling circuit for cooling the motor 4 is the same as that in the air-conditioning/battery coordination control pattern 1-a, and the thermal cycling circuit for cooling the battery 6 is the same as that in the air-conditioning/battery coordination control pattern 2-a.

In the thermal cycling circuit for dry heating by the air conditioner 5, the refrigerant is compressed by the high-pressure compressor 1a into the high-temperature and the high pressure (in the example of FIG. 11, about 120° C. and 11 MPa, and the point A2 in the P-H diagram and the P-T diagram). A part of the high-temperature, high-pressure refrigerant is cooled through the heat exchanger 2 via the refrigerant passage 11 (in the example of FIG. 11, about 30° C. and the point A3 in the P-H diagram and the P-T diagram), is further expanded isenthalpically by the cooling expansion valve V1a into the low temperature (in the example of FIG. 11, about 15° C. and 5 MPa, and the point A4 in the P-H diagram and the P-T diagram), and is supplied from the refrigerant passage 13b to the air conditioner 5. The refrigerant that is supplied to the air conditioner 5 dehumidifies the air flowing into the cabin by absorbing the heat when flowing through a dehumidifying heat exchanger in the air conditioner 5, and returns to the high-pressure compressor 1a through the refrigerant passage 15, the reservoir tank 7, and the refrigerant passage 18 (in the example of FIG. 11, about 30° C. and 5 MPa, and the point A1 in the P-H diagram and the P-T diagram). A part of the high-temperature, high-pressure refrigerant that is not used for dehumidification is expanded by the temperature increase valve V1b (in the example of FIG. 11, about 75° C. and 7 MPa, and the point C1 in the P-H diagram and the P-T diagram), and is supplied from the refrigerant passage 13a to the air conditioner 5. The refrigerant that is supplied to the air conditioner 5 heats the air flowing into the cabin by radiating the heat when flowing through the in-vehicle heat exchanger in the air conditioner 5, then returns to the high-pressure compressor 1a through the refrigerant passage 15, the reservoir tank 7, and the refrigerant passage 18 (in the example of FIG. 11, about 60° C. and 7 MPa, and the point C2 in the P-H diagram and the P-T diagram), and is compressed again with the refrigerant used for the dehumidification.

### Air-Conditioning/Battery Coordination Control Pattern 4-b

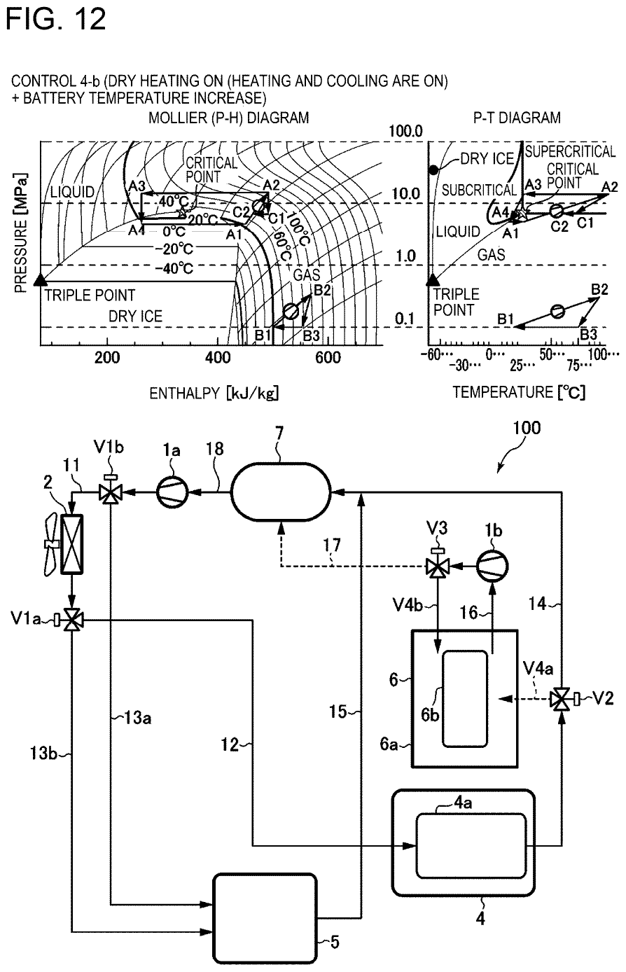

FIG. 12 includes a P-H diagram and a P-T diagram of the cooling cycle of the motor 4, the heating and cooling cycle of the air conditioner 5, and the heating cycle of the battery 6 as well as a view illustrating the flow of the refrigerant in the air-conditioning/battery coordination control pattern 4-b. As illustrated in FIG. 5, the air-conditioning/battery coordination control pattern 4-b is an example of the control pattern when the dry heating request for the air conditioner 5 is present, and the heating request for the battery 6 is present.

In the air-conditioning/battery coordination control pattern 4-b, as illustrated in FIG. 12, in the temperature control system 100, the thermal cycling circuit for cooling the motor 4, the thermal cycling circuit for dry heating by the air conditioner 5, and the thermal cycling circuit for heating the battery 6 independently of the motor 4 are formed. Of these, the thermal cycling circuit for cooling the motor 4 is the same as that in the air-conditioning/battery coordination control pattern 1-a, the thermal cycling circuit for dry heating by the air conditioner 5 is the same as that in the air-conditioning/battery coordination control pattern 4-a, and the thermal cycling circuit for heating the battery 6 is the same as that in the air-conditioning/battery coordination control pattern 2-b.

### Operation and Effects

Next, operation and effects of the temperature control system for the electric vehicle in the present embodiment described above will be described.

According to the temperature control system 100 in the present embodiment, since the common refrigerant that contains CO₂ is used to cool the air conditioner 5, cool the motor 4, and cool the battery 6, the overall configuration of the temperature control system 100 can be made compact. When the motor 4 is cooled and the battery 6 is cooled, the refrigerant that has cooled the motor 4 is supplied to the battery refrigerant expansion valve V4a, is then further expanded and injected into the battery case 6a from the battery refrigerant expansion valve V4a, the cell 6b can be directly cooled by the refrigerant while strength of the structures of the cell 6b and the battery case 6a of the battery 6 is maintained at the same level as that in the related art. In this way, it is possible to control the temperature of the battery 6 with high responsiveness without increasing weight of the battery 6 or increasing manufacturing cost. It is not necessary to provide a separate heat exchanger only to cool the battery 6, and the weight reduction and improved efficiency of the entire temperature control system 100 can thereby be achieved. As a result, even when it is applied to a lightweight sports car, superior handling and acceleration sensations can be achieved, which ensures a system that enhances driving enjoyment.

The refrigerant that has been compressed by the low-pressure compressor 1b after flowing through the battery 6, the refrigerant that has flowed through the air conditioner 5, and the refrigerant that has flowed through the motor 4 can be compressed by the high-pressure compressor 1a. Thus, the high-pressure compressor 1a, which is common for the compression of the refrigerant used to cool the air conditioner 5, the motor 4, and the battery 6, can be used, and the overall configuration of the temperature control system 100 can be made compact.

Since the high-temperature refrigerant that is compressed by the low-pressure compressor 1b is expanded and injected into the battery case 6a from the battery refrigerant expansion valve V4b, the cell 6b can be directly heated by the refrigerant. In this way, it is possible to control the temperature of the battery 6 with the high responsiveness without increasing the weight of the battery 6 or increasing the manufacturing cost.

A required amount of the refrigerant that corresponds to a heat generation amount and the temperature of the battery 6 can be injected into the battery case 6a from the injector, which constitutes the battery refrigerant expansion valves V4a, V4b, at an appropriate pressure with a high degree of accuracy, it is possible to suppress a temperature fluctuation of the cell 6b of the battery 6 and thus to hinder deterioration of the battery 6 by the thermal cycling.

The high-temperature, high-pressure refrigerant that is compressed by the high-pressure compressor 1a is supplied to the air conditioner 5 via the refrigerant passage 13a, and the air conditioner 5 can thereby be heated.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### REFERENCE CHARACTER LIST

1a: high-pressure compressor
1b: low-pressure compressor
2: heat exchanger
4: motor
4a: motor internal structure
5: air conditioner
6: battery
6a: battery case
6b: cell
7: reservoir tank
11 to 18: refrigerant passage
31: refrigerant temperature sensor
32: refrigerant pressure sensor
33: battery temperature sensor
34: motor temperature sensor
35: inside/outside air temperature sensor
36: air-conditioning switch
40: controller
100: temperature control system
200: electric vehicle
V1a: cooling expansion valve
V1b: temperature increase valve
V2: cooling path switching valve
V3: cooling path switching valve
V4a, V4b: battery refrigerant expansion valve

What is claimed is:

1. A temperature control system for an electric vehicle that includes an air-conditioning unit for performing air conditioning, a drive motor, and a battery that accommodates a cell inside a battery case, the temperature control system comprising:
a compressor that compresses a refrigerant containing CO₂;
a heat exchanger that cools the refrigerant compressed by the compressor;
a first expansion valve that expands the refrigerant cooled by the heat exchanger;
an air-conditioning cooling path, through which the refrigerant expanded by the first expansion valve is supplied to the air-conditioning unit when the air-conditioning unit is cooled;
a motor cooling path, through which the refrigerant expanded by the first expansion valve is supplied to the motor when the motor is cooled;
a second expansion valve that expands the refrigerant and injects it into the battery case;
a battery cooling path, through which the refrigerant that has cooled the motor is supplied to the second expansion valve when the motor is cooled and the battery is cooled; and
a collection path, through which the refrigerant that has flowed through the air-conditioning unit, the refrigerant that has flowed through the motor, and the refrigerant that has flowed through the battery are supplied to the compressor.

2. The temperature control system according to claim 1, wherein
the compressor includes:
a first compressor compressing the refrigerant that has flowed through the battery; and
a second compressor compressing the refrigerant that has flowed through the air-conditioning unit and the refrigerant that has flowed through the motor, and
when the motor is cooled and the battery is cooled, the second compressor further compresses the refrigerant compressed by the first compressor.

3. The temperature control system according to claim 2, further including:
a battery heating path, through which the refrigerant compressed by the first compressor is supplied to the second expansion valve when the battery is heated.

4. The temperature control system according to claim 1, wherein the second expansion valve includes:
a common rail that stores the refrigerant; and
an injector that injects the refrigerant stored in the common rail into the battery case.

5. The temperature control system according to claim 2, wherein the second expansion valve includes:
a common rail that stores the refrigerant; and
an injector that injects the refrigerant stored in the common rail into the battery case.

6. The temperature control system according to claim 3, wherein the second expansion valve includes:
a common rail that stores the refrigerant; and
an injector that injects the refrigerant stored in the common rail into the battery case.

7. The temperature control system according to claim 1, further comprising:
an air-conditioning heating path, through which the refrigerant compressed by the compressor is supplied to the air-conditioning unit when the air-conditioning unit is heated.

8. The temperature control system according to claim 2, further comprising:
an air-conditioning heating path, through which the refrigerant compressed by the compressor is supplied to the air-conditioning unit when the air-conditioning unit is heated.

9. The temperature control system according to claim 3, further comprising:
an air-conditioning heating path, through which the refrigerant compressed by the compressor is supplied to the air-conditioning unit when the air-conditioning unit is heated.
